(19) United States
(12) Patent Application Publication
(10) Pub. No.: US 2017/0061278 A1
(43) Pub. Date: Mar. 2, 2017

(54) SYNAPSE AND NEUROMORPHIC DEVICE INCLUDING THE SAME

(71) Applicant: SK hynix Inc., Icheon (KR)

(72) Inventor: Hyung-Dong LEE, Icheon (KR)

(21) Appl. No.: 15/012,523

(22) Filed: Feb. 1, 2016

(30) Foreign Application Priority Data
Aug. 31, 2015 (KR) 10-2015-0122569

(51) Int. Cl. G06N 3/063; G06N 3/08

(52) U.S. Cl. CPC G06N 3/0635; G06N 3/08

(57) ABSTRACT

A neuromorphic device may include: first to N-th row lines; first to M-th column lines; first to N-th first neuron circuits coupled to the first to N-th row lines, respectively; first to M-th second neuron circuits coupled to the first to M-th column lines, respectively; a plurality of synapses positioned at intersections of the first to N-th row lines and the first to M-th column lines, respectively, each of the plurality of synapses comprising a variable resistance element and a first transistor which are coupled in series, wherein N and M are natural numbers equal to or larger than two; and a t-th gate line to which gates of first transistors coupled to a t-th column line among the first to M-th column lines are coupled, wherein t is a natural number ranging from 1 to M.

### CROSS-REFERENCE TO RELATED APPLICATIONS

The present application claims priority of Korean Patent Application No. 10-2015-0122569, filed on Aug. 31, 2015, which is incorporated herein by reference in its entirety.

### BACKGROUND

1. Field

This patent document relates to neuromorphic devices, and their applications in electronic devices or systems.

2. Description of the Related Art

Recently, as electronic devices are improved in size, power consumption, and performance, and diversified to various forms, the electronic devices have required technology of efficiently processing large-volume information. In particular, neuromorphic technology for mimicking neuro-biological architectures present in a human nervous system has received much attention to implement the technology of efficiently processing large-volume information. The human nervous system includes several hundred billions of neurons and synapses serving as junctions between the respective neurons. According to the neuromorphic technology, neuron circuits and synapse circuits corresponding to the neurons and the synapses, respectively, are designed to implement a neuromorphic device. The neuromorphic device may be utilized in various fields such as data and pattern recognition.

### SUMMARY

Various embodiments are directed to a synapse and a neuromorphic device including the same, which are capable of improving a learning operation and pattern recognition.

In an embodiment, a neuromorphic device may include: first to N-th row lines; first to M-th column lines; first to N-th first neuron circuits coupled to the first to N-th row lines, respectively; first to M-th second neuron circuits coupled to the first to M-th column lines, respectively; a plurality of synapses positioned at intersections of the first to N-th row lines and the first to M-th column lines, respectively, each of the plurality of synapses comprising a variable resistance element and a first transistor which are coupled in series, wherein N and M are natural numbers equal to or larger than two; and a t-th gate line to which gates of first transistors coupled to a t-th column line among the first to M-th column lines are coupled, wherein t is a natural number ranging from 1 to M.

Implementations of the above neuromorphic device may include one or more the following.

When the t-th column line is a column line having learned specific data, the t-th gate line is driven to turn off the first transistors coupled to the t-th column line during a learning operation of a u-th column line, wherein u is a natural number ranging from 1 to M and is not equal to t. During the learning process of the u-th column line, the t-th column line is in a floating state. During the learning process of the u-th column line, a u-th gate line is driven to turn on first transistors coupled to the u-th column line. The t-th gate line has the same extension direction as the t-th column line. The neuromorphic device further comprising a gate control circuit coupled to the t-th gate line, wherein a t-th second neuron circuit coupled to the t-th column line and the gate control circuit coupled to the t-th gate line are positioned in opposite sides with respect to the plurality of synapses in the extension direction of the t-th column line. The variable resistance element has electrical conductance which gradually changes according to electrical pulses inputted to the first to the N-th row lines, respectively. The variable resistance element exhibits an analog behavior according to electrical pulses inputted to the first to N-th row lines, respectively. Each of the plurality of synapses further comprises a second transistor that is coupled to and disposed between the variable resistance element and the first transistor. Relative positions of the variable resistance element, the first transistor, and the second transistor are variable. The neuromorphic device further comprising an s-th gate line to which gates of second transistors coupled to an s-th row line among the first to N-th row lines are coupled, wherein s is a natural number ranging from 1 to N. The s-th gate line has the same extension direction as the s-th row line. The neuromorphic device further comprising a gate control circuit coupled to the s-th gate line, wherein an s-th first neuron circuit coupled to the s-th row line and the gate control circuit coupled to the s-th gate line are positioned in opposite sides with respect to the plurality of synapses in the extension direction of the s-th row line.

In another embodiment, a synapse may include: a first transistor; and a variable resistance element coupled in series to the first transistor, wherein the first transistor is turned on during a learning operation, and turned off when the learning operation ends.

The above synapse may further comprise a second transistor coupled to and disposed between the first transistor and the variable resistance element, wherein the first transistor is used to control a leakage current on a first set of row and column bases, and the second transistor is used to control a leakage current on a second set of the row and column bases.

These and other aspects, implementations and associated advantages are described in greater detail in the drawings, the description and the claims.

### BRIEF DESCRIPTION OF THE DRAWINGS

FIG. 1A is a diagram illustrating a neuromorphic device in accordance with a comparative example.

FIGS. 1B and 1C are diagrams for describing a method of operating the neuromorphic device of FIG. 1A.

FIG. 2A is a diagram illustrating a neuromorphic device in accordance with an embodiment of the present disclosure.

FIGS. 2B and 2C are diagrams for describing a method of operating the neuromorphic device of FIG. 2A.

FIG. 3 is a diagram illustrating a neuromorphic device in accordance with another embodiment of the present disclosure.

FIG. 4 is a diagram illustrating a pattern recognition system in accordance with an embodiment of the present disclosure.

### DETAILED DESCRIPTION

Various examples and implementations of the disclosed technology are described below in detail with reference to the accompanying drawings.

The drawings may not be necessarily to scale and in some instances, proportions of at least some of structures in the drawings may have been exaggerated in order to clearly illustrate certain features of the described examples or implementations. In presenting a specific example in a drawing or description having two or more layers in a multi-layer structure, the relative positioning relationship of such layers or the sequence of arranging the layers as shown reflects a particular implementation for the described or illustrated example and a different relative positioning relationship or sequence of arranging the layers may be possible. In addition, a described or illustrated example of a multi-layer structure may not reflect all layers present in that particular multilayer structure (e.g., one or more additional layers may be present between two illustrated layers). As a specific example, when a first layer in a described or illustrated multi-layer structure is referred to as being “on” or “over” a second layer or “on” or “over” a substrate, the first layer may be directly formed on the second layer or the substrate but may also represent a structure where one or more other intermediate layers may exist between the first layer and the second layer or the substrate.

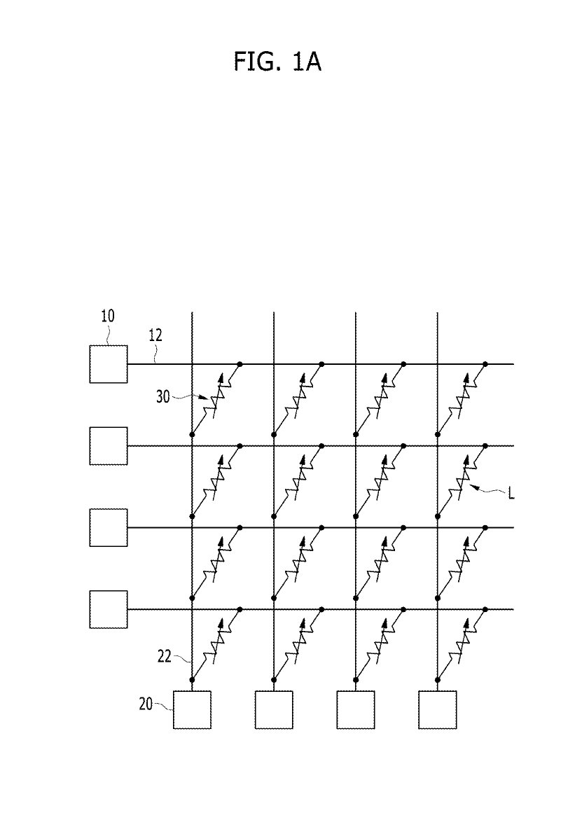

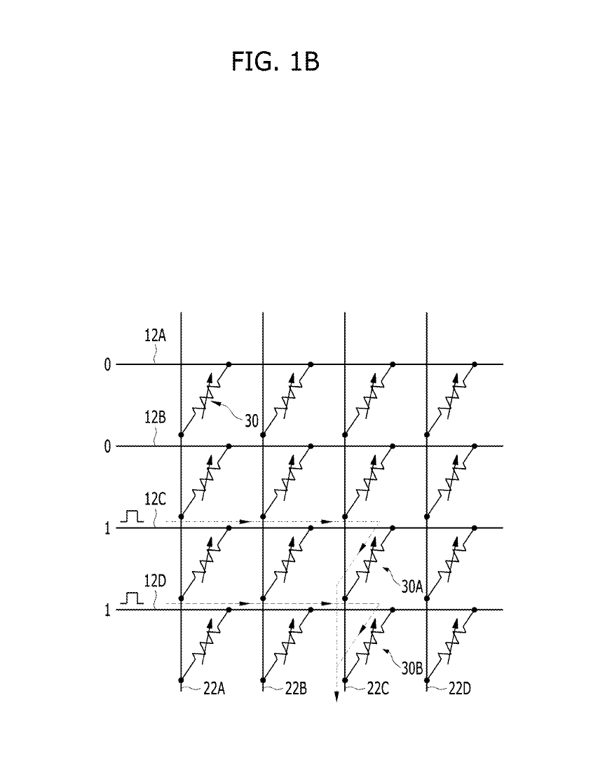

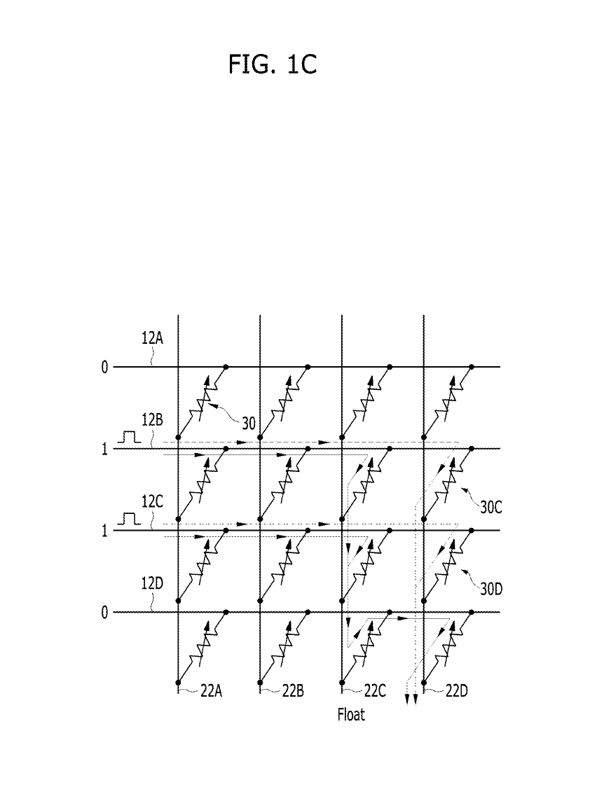

FIG. 1A is a diagram illustrating a neuromorphic device in accordance with a comparative example, and FIGS. 1B and 1C are diagrams for describing a method of operating the neuromorphic device of FIG. 1A.

Referring to FIG. 1A, the neuromorphic device may include a plurality of presynaptic neurons 10, a plurality of postsynaptic neurons 20, and a plurality of synapses 30 for coupling the plurality of presynaptic neurons 10 to the plurality of postsynaptic neurons 20, respectively.

For illustrative convenience, FIG. 1A illustrates the neuromorphic device that includes four presynaptic neurons 10, four postsynaptic neurons 20, and 16 synapses 30, but the numbers of neurons and synapses may be variable. When the number of presynaptic neurons 10 is N and the number of postsynaptic neurons 20 is M, N*M synapses 30 may be arranged in a matrix shape, wherein N and M are natural numbers equal to or more than 2, and may or may not be equal to each other.

For this configuration, the neuromorphic device may further include a plurality of lines 12 and a plurality of lines 22. The plurality of lines 12 is coupled to the respective presynaptic neurons 10 and extends in a first direction, for example, a horizontal direction with respect to the orientation of FIG. 1A. The plurality of lines 22 is coupled to the respective postsynaptic neurons 20 and extends in a second direction crossing the first direction, for example, a vertical direction with respect to the orientation of FIG. 1A. Hereafter, for convenience of description, the line 12 extending in the first direction will be referred to as a row line, and the line 22 extending in the second direction will be referred to as a column line. The plurality of synapses 30 may be arranged at the respective intersections of the row lines 12 and the column lines 22, and couple the corresponding row lines 12 to the corresponding column lines 22.

Each of the presynaptic neurons 10 may transmit a signal to a corresponding row line 12, and each of the postsynaptic neurons 20 may receive, through a corresponding column line 22, a synaptic signal corresponding to the signal of the corresponding row line 12 that passed through a corresponding synapse 30 disposed at an intersection of the corresponding row line 12 and the corresponding column line 22.

The row line 12 may correspond to an axon of the presynaptic neuron 10, and the column line 22 may correspond to a dendrite of the postsynaptic neuron 20. However, whether a neuron is a presynaptic neuron or a postsynaptic neuron may be determined through the relationship between the neuron and another neuron. For example, when the presynaptic neuron 10 receives a synaptic signal from another neuron, the presynaptic neuron 10 may function as a postsynaptic neuron. Similarly, when the postsynaptic neuron 20 transmits a signal to another neuron, the postsynaptic neuron 20 may function as a presynaptic neuron. The presynaptic neuron 10 and the postsynaptic neuron 20 may be implemented with various circuits such as CMOSs. The synapse 30 may couple the presynaptic neuron 10 to the postsynaptic neuron 20. The synapse 30 may include a variable resistance element. The variable resistance element may indicate an element that has electrical conductance changing according to a voltage or current applied thereto. The variable resistance element may have a single-layer structure or multi-layer structure which includes various materials having a plurality of resistance states. The various materials may include a transition metal oxide, a metal oxide such as a perovskite-based material, a phase change material such as a chalcogenide-based material, a ferrodielectric material, and a ferromagnetic material. However, the variable resistance element of the synapse 30 may exhibit an analog behavior in which electrical conductance gradually changes according to the number and/or magnitude of electrical pulses input thereto, unlike variable resistance elements used for memory devices such as RRAM, PRAM, FRAM, and MRAM devices. In this case, the electrical conductance of the variable resistance element in the synapse 30 may change when the magnitude of the applied voltage or current is larger than a predetermined threshold value, and may not change when the magnitude of the applied voltage or current is smaller than the predetermined threshold value.

Referring to FIGS. 1B and 1C, a learning operation of the neuromorphic device of FIG. 1A will be described hereinafter. For convenience of description, the row lines 12 may be sequentially referred to as first to fourth row lines 12A to 12D from the top with respect to the orientation of FIGS. 1B and 1C, and the column lines 22 may be sequentially referred to as first to fourth column lines 22A to 22D from the left with respect to the orientation of FIGS. 1B and 1C.

First, referring to FIG. 1B, each of the synapses 30 may be initially set in a state where electrical conductance of a variable resistance element is relatively low. That is, the variable resistance element is in a high resistance state. Each of the synapses 30 may have a predetermined threshold value. The electrical conductance of the synapse 30 may not change when a voltage or current having smaller magnitude than the predetermined threshold value is applied to the synapse 30, or may change when a voltage or current having larger magnitude than the predetermined threshold value is applied to the synapse 30. The electrical conductance of the synapse 30 may have various levels according to the magnitude of a voltage or current applied to the synapse 30.

In the learning operation, an input signal corresponding to specific data may be provided to the row lines 12 in response to outputs of the corresponding presynaptic neurons 10. At this time, the input signal may appear in the form of an electrical pulse applied to each of the row lines 12. For example, when an input signal corresponding to data ‘0011’ is provided to the first to fourth row lines 12A to 12D, an electrical pulse having predetermined magnitude may be applied to each of the third and fourth row lines 12C and 12D, and no electrical pulse may be applied to each of the first and second row lines 12A and 12B.

When it is supposed that the third column line 22C is selected to learn specific data, the third column line 22C may be driven to apply a larger voltage than a predetermined threshold value to two synapses, e.g., 30A and 30B, positioned at intersections of the third and fourth row lines 12C and 12D and the third column line 22C. The first, second, and fourth column lines 22A, 22B, and 22D may be driven to apply a smaller voltage than the predetermined threshold value to other synapses 30 positioned at intersections of the first, second, and fourth column lines 22A, 22B, and 22D and the third and fourth row lines 12C and 12D. For example, when it is supposed that a voltage required for changing the electrical conductance of the synapse 30 is represented by Vw, electrical pulses applied to the third and fourth row lines 12C and 12D may have a voltage corresponding to Vw, and a voltage applied to the third column line 22C may have a value corresponding to 0V. A voltage applied to each of the first, second, and fourth column lines 22A, 22B, and 22D may have a value in a range of 0V and Vw, for example, ½Vw.

When the first to fourth row lines 12A to 12D and the first to fourth column lines 22A to 22D are driven in such a manner, the electrical conductance of the two synapses 30A and 30B positioned at the intersections of the third and fourth row lines 12C and 12D and the third column line 22C may gradually increase. Thus, a current flowing to the third column line 22C through the corresponding synapses 30A and 30B may gradually increase. The current flow is indicated by a dotted arrow in FIG. 1B. When the current flowing through the third column line 22C reaches a predetermined threshold value, the third column line 22C may be set to a column line having learned the specific data ‘0011.’

In another example, any of the first to fourth column lines 22A to 22D may not be set to a column line to learn specific data. In this case, while electrical pulses corresponding to the specific data are applied to the first to fourth row lines 12A to 12D, a current flowing through each of the first to fourth column lines 22A to 22D may be measured, and a column line, among the first to fourth column lines 22A to 22D, which first reaches the predetermined threshold current may be set to the column line having learned the specific data. For convenience of description, it is supposed that the third column line 22C is the column line having learned the specific data ‘0011.’

In any cases, when the learning operation ends, the column line having learned the specific data, for example, the third column line 22C, may be floated in order to control another column line to learn another data. FIG. 1C illustrates the case in which another data is learned by another column line, e.g., 22D, in a state where the third column line 22C is floated. In FIG. 1C, data ‘0110’ may be learned by the fourth column line 22D.

Referring to FIG. 1C, as the first to fourth row lines 12A to 12D and the first to fourth column lines 22A to 22D are driven in the above-described manner, the data ‘0110’ may be learned by the fourth column line 22D. In other words, an electrical pulse having predetermined magnitude may be applied to each of the second and third row lines 12B and 12C, and no electrical pulse may be applied to each of the first and fourth row lines 12A and 12D. When it is supposed that the fourth column line 22D is set to a column line to learn the specific data ‘0110,’ the fourth column line 22D may be driven to apply a larger voltage than a predetermined threshold value to two synapses, e.g., 30C and 30D, positioned at intersections of the second and third row lines 12B and 12C and the fourth column line 22D, and the first and second column lines 22A and 22B may be driven to apply a smaller voltage than the predetermined threshold value to other synapses 30 positioned at intersections of the second and third row lines 12B and 12C and the first and second column lines 22A and 22B. In this case, a current flow to the fourth column line 22D through the corresponding synapses 30C and 30D is indicated by a dotted arrow in FIG. 1C.

However, since the third column line 22C having learned the specific data ‘0011’ is in a floating state during the learning operation of the data ‘0110,’ the third column line 22C may have a potential larger than 0V and smaller than Vw. As a result, while the fourth column line 22D is controlled to learn the data ‘0110,’ a leakage current may occur in the neuromorphic device as indicated by a solid arrow in FIG. 1C.

This leakage current may increase a current flowing through the fourth column line 22D. Thus, it may make the current flowing through the fourth column line 22D reach the predetermined threshold current before the fourth column line 22D learns the data ‘0110.’ In other words, the current flowing through the fourth column line 22D may be over-estimated and thus cause an error in which it is recognized that the fourth column line 22D has learned the data ‘0110’ before the fourth column lien 22D learns the data ‘0110.’ Such an error may become more serious as the number of column lines in a floating state during a learning operation increases and the size of an array including a plurality of row lines and a plurality of column lines increases.

Embodiments of the present disclosure provide a neuromorphic device capable of preventing such an error and an operating method thereof.

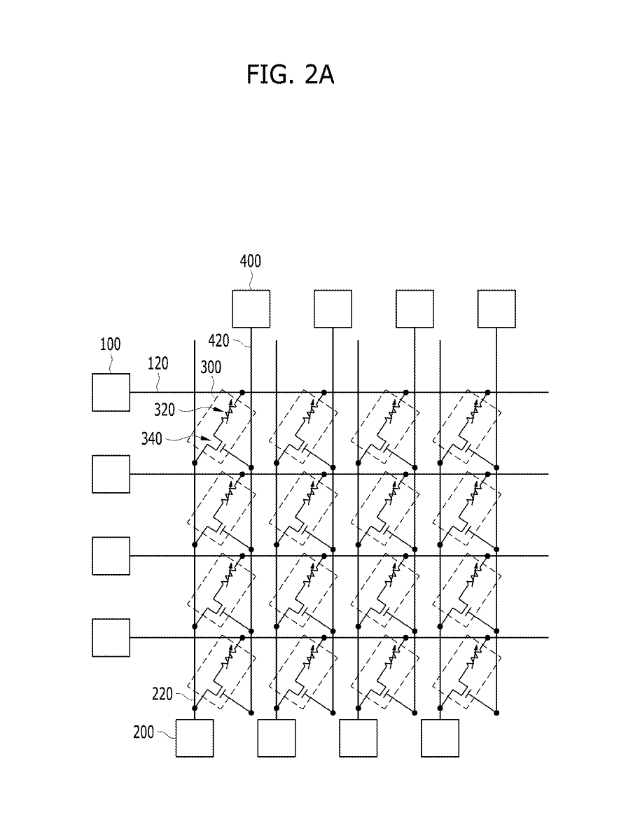

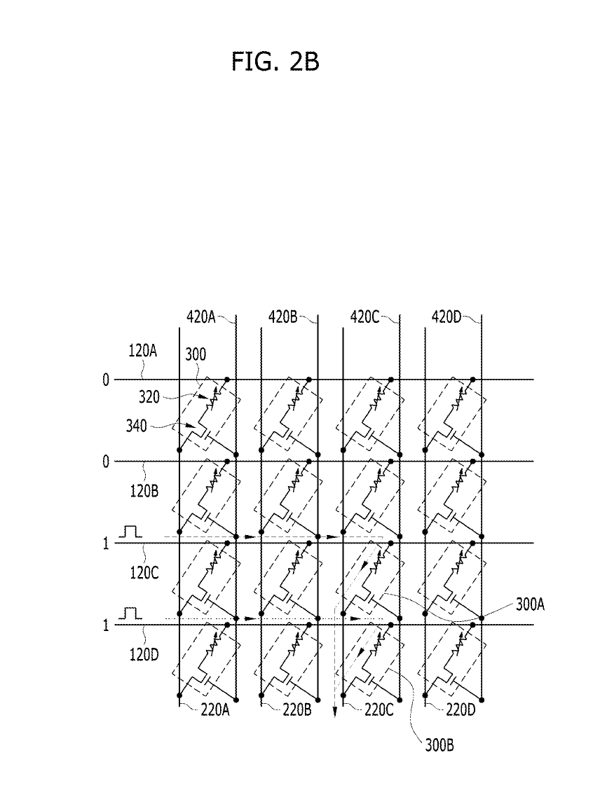

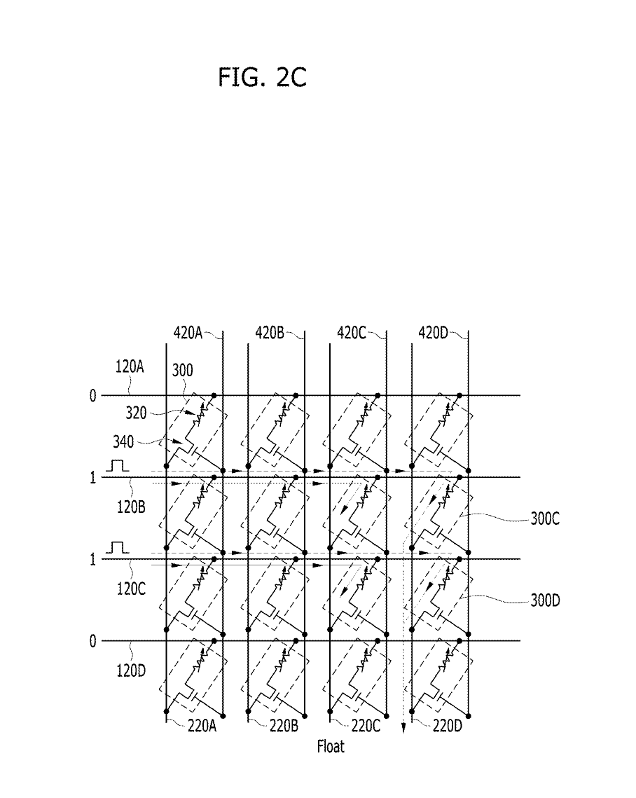

FIG. 2A is a diagram illustrating a neuromorphic device in accordance with an embodiment of the present disclosure, and FIGS. 2B and 2C are diagrams for describing a method of operating the neuromorphic device of FIG. 2A.

Referring to FIG. 2A, the neuromorphic device may include a plurality of presynaptic neurons 100, a plurality of postsynaptic neurons 200, a plurality of row lines 120, a plurality of column lines 220, and a plurality of synapses 300. The plurality of row lines 120 may be coupled to the respective presynaptic neurons 100 and extend in a first direction, for example, a horizontal direction with respect to the orientation of FIG. 2A. The plurality of column lines 220 may be coupled to the respective postsynaptic neurons 200 and extend in a second direction crossing the first direction, for example, a vertical direction with respect to the orientation of FIG. 2A. The plurality of synapses 300 may be arranged at the respective intersections of the row lines 120 and the column lines 220, and couple the corresponding row lines 120 to the corresponding column lines 220.

Each of the synapses 300 may include a variable resistance element 320 and a transistor 340 which are coupled in series. In the present embodiment, the variable resistance element 320 may be coupled to a corresponding row line 120, and the transistor 340 may be coupled to and disposed between the variable resistance element 320 and a corresponding column line 220. That is, the variable resistance element 320 may have one end coupled to the corresponding row line 120 and the other end coupled to one of source and drain of the transistor 340, and the other one of the source and drain of the transistor 340 may be coupled to the corresponding column line 220. In another embodiment, positions of the variable resistance element 320 and the transistor 340 may be changed in such a manner that the variable resistance element 320 is coupled to and disposed between the corresponding column line 220 and the transistor 340 coupled to the corresponding row line 120.

The neuromorphic device of FIG. 2A may further include a plurality of gate lines 420. Transistors 340 coupled to a same column line 220 may have gates coupled to a same gate line 420, such that the transistors 340 coupled to the same column line 220 may be controlled together. The gate lines 420 may extend in the same direction as the column lines 220, for example, the second direction. The number of gate lines 420 may be equal to the number of column lines 220. Each of the gate lines 420 may have one end coupled to a corresponding gate control circuit 400 for providing a required gate voltage to transistors 340 coupled thereto. The gate control circuits 400 may be positioned in the opposite side of the postsynaptic neurons 200 in the second direction. Thus, an area for forming the postsynaptic neurons 200 and the gate control circuits 400 can be easily secured.

As such, when each of the synapses 300 includes the transistor 340 and the gates of the transistors 320 that are coupled to the same gate line 420 are controlled together in the second direction, the above-described error that may occur in the learning and recognition operation can be improved. This configuration will be described in more detail with reference to FIGS. 2B and 2C.

The variable resistance element 320 may indicate an element that has electrical conductance changing according to a voltage or current applied thereto. The variable resistance element 320 may have a single-layer structure or multi-layer structure which includes various materials having a plurality of resistance states. For example, the various materials may include a transition metal oxide, a metal oxide such as a perovskite-based material, a phase change material such as a chalcogenide-based material, a ferrodielectric material, and a ferromagnetic material. In accordance with the embodiment of the present disclosure, the variable resistance element 320 may exhibit an analog behavior in which electrical conductance gradually changes according to the number and/or magnitude of electrical pulses inputted thereto through the row line 120.

Referring to FIGS. 2B and 2C, a learning operation of the neuromorphic device of FIG. 2A will be described hereinafter. For convenience of description, the row lines 120 may be sequentially referred to as first to fourth row lines 120A to 120D from the top with respect to the orientation of FIGS. 2B and 2C, the column lines 220 may be sequentially referred to as first to fourth column lines 220A to 220D from the left with respect to the orientation of FIGS. 2B and 2C, and the gate lines 420 may be sequentially referred to as first to fourth gate lines 420A to 420D from the left with respect to the orientation of FIGS. 2B and 2C.

First, referring to FIG. 2B, each of the variable resistance elements 320 may be initially set in a state where its electrical conductance is relatively low, that is, in a high resistance state.

In this initial state, an input signal corresponding to specific data may be provided to the first to fourth row lines 120A to 120D in response to outputs of the presynaptic neurons 100. For example, when an input signal corresponding to data ‘0011’ is provided to the first to fourth row lines 120A to 120D, an electrical pulse having predetermined magnitude may be applied to each of the third and fourth row lines 120C and 120D, and no electrical pulse may be applied to each of the first and second row lines 120A and 120B.

When it is supposed that the third column line 220C is selected to learn the data ‘0011.’ The third column line 220C may be driven to apply a larger voltage than a predetermined threshold value to two synapses, e.g., 300A and 300B, positioned at intersections of the third and fourth row lines 120C and 120D and the third column line 220C. The first, second, and fourth column lines 220A, 220B, and 220D may be driven to apply a smaller voltage than the predetermined threshold value to other synapses 300 positioned at intersections of the first, second, and fourth column lines 220A, 220B, and 220D and the third and fourth row lines 120C and 120D. For example, when it is supposed that a voltage required for changing the electrical conductance of the variable resistance element 320 is represented by Vw, the electrical pulse applied to each of the third and fourth row lines 120C and 120D may have a voltage corresponding to Vw, and a voltage applied to the third column line 220C may have a value corresponding to 0V. A voltage applied to each of the first, second, and fourth column lines 220A, 220B, and 220D may have a value between 0V and Vw, for example, ½Vw.

At this time, in order to control the third column line 220C to learn the data ‘0011,’ transistors 340 coupled to the third column line 220C may be turned on. For the purpose, a corresponding gate control circuit 400 may supply a certain voltage to the third gate line 420C to which the transistors 340 of the two synapses 300A and 300B are coupled, the certain voltage having a voltage level capable of turning on the transistors 340 coupled to the third gate line 420C and the third column line 220C. Meanwhile, during the learning operation of the data ‘0011,’ transistors 340 coupled to the first, second, and fourth column lines 220A, 220B, and 220D may be turned on or off. That is, corresponding gate control circuits 400 may supply a turn-on voltage to gates of the transistors 340 coupled to the first, second, and fourth column lines 220A, 220B, and 220D through the first, second, and fourth gate lines 420A, 420B, and 420D, respectively, or supply no voltage to the first, second, and fourth gate lines 420A, 420B, and 420D.

When the first to fourth row lines 120A to 120D, the first to fourth column lines 220A to 220D, and the first to fourth gate lines 420A to 420D are driven in such a manner, the electrical conductance of the two synapses 300A and 300B positioned at the intersections of the third and fourth row lines 120C and 120D and the third column line 220C may gradually increase, and a current flowing into the third column line 220C through the two synapses 300A and 300B may gradually increase. The current flow is indicated by a dotted arrow in FIG. 2B. When the current flowing through the third column line 220C reaches a predetermined threshold value, the third column line 220C may be set to a column line having learned the specific data ‘0011.’

In another embodiment, any of the column lines 220A to 220D may not be set to a column line to learn specific data. In this case, while the electrical pulses corresponding to the data ‘0011’ are applied to the first to fourth row lines 120A to 120D, a current flowing through each of the first to fourth column lines 220A to 220D may be measured, and a column line, among the first to fourth column lines 220A to 220D, which first reaches the predetermined threshold current may be set to a column line having learned the specific data. In this embodiment, the transistors 340 coupled to the first, second, and fourth column lines 220A, 220B, and 220D as well as the transistors 340 coupled to the third column line 220C need to be turned on. For this operation, the gate control circuits 400 may supply the turn-on voltage to the gate lines 420, respectively. For convenience of description, in the other embodiment, it is supposed that the third column line 220C is the column line having learned the specific data ‘0011.’

FIG. 2C illustrates the case in which another data ‘0110’ is learned by another column line, e.g., 220D in a state where the third column line 220C has learned the specific data ‘0011.’

Referring to FIG. 2C, the third column line 220C having learned the data ‘0011’ may be floated. In this state, an input signal corresponding to the data ‘0110’ may be provided to the first to fourth row lines 120A to 120D in response to outputs of the presynaptic neurons 100. That is, no electrical pulse may be applied to each of the first and fourth row lines 120B and 120D, and an electrical pulse having predetermined magnitude may be applied to each of the second and third row lines 120A and 120C.

When it is supposed that a column line to learn the data ‘0110’ is set to the fourth column line 220D, the fourth column line 220D may be driven to apply a larger voltage than a predetermined threshold value to two synapses, e.g., 300C and 300D, positioned at intersections of the second and third row lines 120B and 120C and the fourth column line 220D, and the first and second column lines 220A and 220B may be driven to apply a smaller voltage than the predetermined threshold value to other synapses 300 positioned at intersections of the second and third row lines 120B and 120C and the first and second column lines 220A and 220B. As described above, at this time, the third column line 220C may be set in a floating state.

In order to control the fourth column line 220D to learn the data ‘0110,’ the transistors 340 coupled to the fourth column line 220D may be turned on. On the other hand, the transistors 340 coupled to the third column line 220C in a floating state may be turned off. For this purpose, a voltage capable of turning off the transistor 340 coupled to the fourth column line 220D may be applied to the third gate line 420C. In this case, although a leakage current flow is generated as indicated by a solid arrow in FIG. 2C because the potential of the third column line 220C having learned the data ‘0011’ is in a range of 0V and Vw, the leakage current flow may be blocked by the transistors 340 that are coupled to the third column line 220C and turned off. As a result, a current flowing through the fourth column line 220D may be prevented from being over-estimated by the leakage current, which may reduce a learning and recognition error.

During the present learning operation, transistors 340 coupled to the first and second column lines 220A and 220B may be turned on or off.

When the first to fourth row lines 120A to 120D, the first to fourth column lines 220A to 220D, and the first to fourth gate lines 420A to 420D are driven in such a manner, the electrical conductance of the two synapses 300C and 300D positioned at the intersections of the second and third row lines 120B and 120C and the fourth column line 220D may gradually increase, and the current flowing to the fourth column line 220D through the corresponding synapses 300C and 300D may gradually increase. The current flow is indicated by a dotted arrow in FIG. 2C. This current flow may not include a leakage current flow. When the current flowing through the fourth column line 220D reaches a predetermined threshold value, the fourth column line 220D may be set to a column line having learned the data ‘0110.’

In another embodiment, any of the first to fourth column lines 220A to 220D may not be set to a column line to learn specific data. In this case, while electrical pulses corresponding to the data ‘0110’ are applied to the first to fourth row lines 120A to 120D, a current flowing through each of the first to fourth column lines 220A to 220D may be measured, and a column line, among the first to fourth column lines 220A to 220D, which first reaches the predetermined threshold current may be set to the column line having learned the specific data ‘0110.’ In this embodiment, the transistors 340 coupled to the first and second column lines 220A and 220B as well as the transistors 340 coupled to the fourth column line 220D need to be turned on. On the other hand, the transistors 340 coupled to the third column line 220C having learned the data ‘0011’ needs to be turned off.

The above-described neuromorphic device can control the transistors included in the synapses on a learning basis, that is, a column basis, and thus block a leakage current that may be caused by the potential of the learned column line in the column direction. As a result, a learning and recognition error can be reduced.

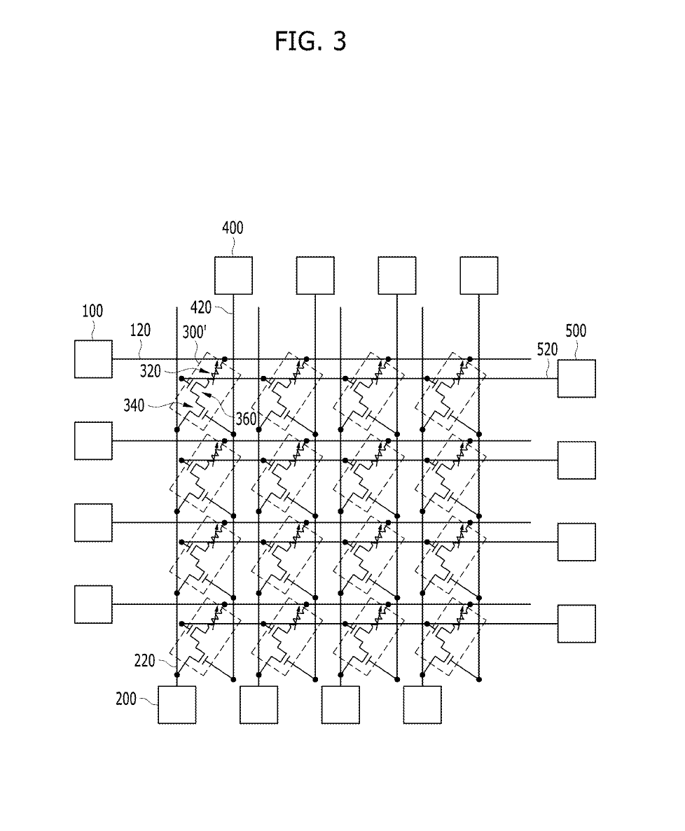

In another embodiment, a synapse of a neuromorphic device may further include an additional transistor controlled on a row basis, thereby blocking a leakage current in the row direction. This embodiment will be described in more detail with reference to FIG. 3.

FIG. 3 is a diagram illustrating a neuromorphic device in accordance with another embodiment of the present disclosure. The following descriptions will be focused on differences from the neuromorphic device of FIG. 2A.

Referring to FIG. 3, the neuromorphic device may include a plurality of presynaptic neurons 100, a plurality of postsynaptic neurons 200, a plurality of row lines 120, a plurality of column lines 220, and a plurality of synapses 300′. The plurality of row lines 120 may be coupled to the respective presynaptic neurons 100 and extend in a first direction, for example, a horizontal direction with respect to the orientation of FIG. 3. The plurality of column lines 220 may be coupled to the respective postsynaptic neurons 200 and extend in a second direction crossing the first direction, for example, a vertical direction with respect to the orientation of FIG. 3. The plurality of synapses 300′ may be arranged at the respective intersections of the row lines 120 and the column lines 220 and couple the corresponding row lines 120 to the corresponding column lines 220.

Each of the synapses 300′ may include a variable resistance element 320 and a transistor 340. In addition to the variable resistance element 320 and the transistor 340, the synapse 300′ may include an additional transistor 360. One of source and drain of the additional transistor 360 may be coupled to the variable resistance element 320, and the other one of the source and drain of the additional transistor 360 may be coupled to the transistor 340. In another embodiment, positions of the variable resistance element 320, the transistor 340, and the additional transistor 360 may be changed as long as the variable resistance element 320, the transistor 340, and the additional transistor 360 are coupled in series.

The neuromorphic device of FIG. 3 may further include a plurality of gate lines 420. Transistors 340 coupled to a same column line 220 may have gates coupled to a same gate line 420, such that the transistors 340 coupled to the same column line 220 may be controlled together.

Furthermore, the neuromorphic device of FIG. 3 may include a plurality of additional gate lines 520. Additional transistors 360 coupled to a same row line 120 may have gates coupled to a same additional gate line 520, such that the additional transistors 360 coupled to the same row line 120 may be controlled together. The additional gate lines 520 may extend in the same direction as the row lines 120, for example, the first direction. The number of additional gate lines 520 may be equal to the number of row lines 120. Each of the additional gate lines 520 may have one end coupled to a corresponding additional gate control circuit 500 for providing a required gate voltage to gates of the additional transistors 360 coupled thereto. The additional gate control circuits 500 may be positioned in the opposite side of the presynaptic neurons 100 in the first direction. Thus, an area for forming the presynaptic neurons 100 and the additional gate control circuits 500 can be easily secured.

When each of the synapses 300′ further includes an additional transistor 360 and gates of additional transistors 360 commonly coupled to each other are controlled together in the row direction, the additional transistors 360 may be turned on or off on a row basis, thereby blocking a leakage current in the row direction.

In accordance with the embodiments of the present disclosure, a learning operation and pattern recognition of a neuromorphic device can be improved.

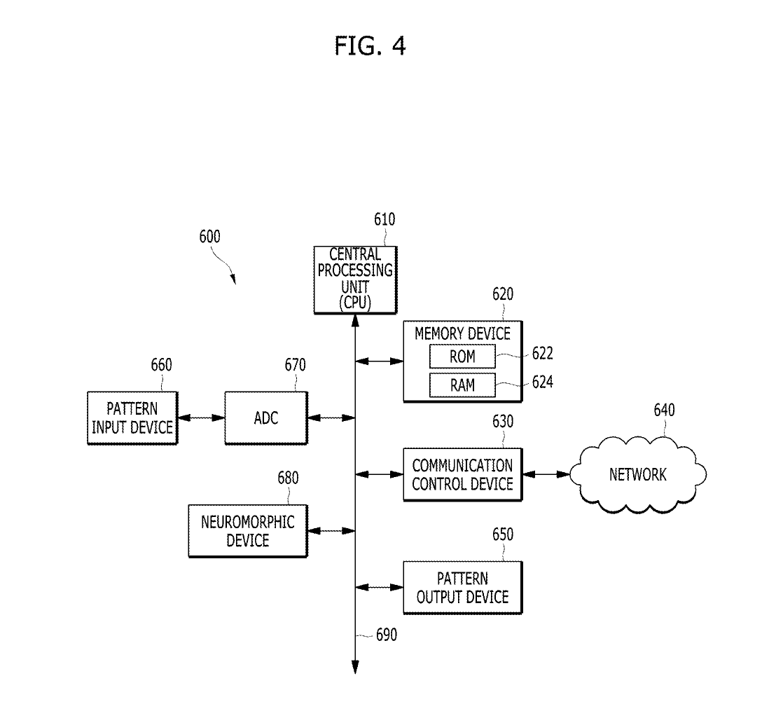

The neuromorphic devices in accordance with the above-described embodiments may be used for various devices or systems. This application will be described in detail with reference to FIG. 4.

FIG. 4 is a diagram illustrating a pattern recognition system in accordance with an embodiment of the present disclosure. The pattern recognition system may include any of various types of pattern recognition systems such as a speech recognition system and an image recognition system. The pattern recognition system in accordance with the embodiment of the present disclosure may include any of the neuromorphic devices in accordance with the above-described embodiments.

Referring to FIG. 4, the pattern recognition system 600 may include a CPU 610, a memory device 620, a communication control device 630, a network 640, a pattern output device 650, a pattern input device 660, an analog-digital converter (ADC) 670, a neuromorphic device 680, and a bus line 690.

The CPU 610 may generate and transmit various signals for a learning operation of the neuromorphic device 680, and perform a variety of processes and functions for recognizing patterns such as voice and image patterns according to an output of the neuromorphic device 680. The CPU 610 may be coupled to the memory device 620, the communication control device 630, the pattern output device 650, the ADC 670, and the neuromorphic device 680 through the bus line 690.

The memory device 620 may store various pieces of information requested by the pattern recognition system 600. The memory device 620 may include different types of memories. For example, the memory device 620 may include a ROM 622 and a RAM 624. The ROM 622 may store a variety of programs or data which are used for the CPU 610 in order to control the learning operation and pattern recognition of the neuromorphic device 680. The RAM 624 may download and store a program or data of the ROM 622, or store voice and image data which are converted and analyzed by the ADC 670.

The communication control device 630 may exchange recognized voice and image data with another communication control device through a network 640.

The pattern output device 650 may output the recognized voice and image data using various methods. For example, the pattern output device 650 may include a printer, a display device, or the like, and output the voice in a waveform or display the image data.

The pattern input device 660 may receive analog voice and images, and include a microphone and a camera.

The ADC 670 may convert analog data inputted through the pattern input device 660 into digital data, and analyze the digital data.

The neuromorphic device 680 may perform the learning operation and pattern recognition using the data outputted from the ADC 670, and output data corresponding to a recognized pattern. The neuromorphic device 680 may include one or more of the neuromorphic devices in accordance with the above-described embodiments. In an embodiment, the neuromorphic device 680 may include first to N-th row lines; first to M-th column lines; first to N-th first neuron circuits coupled to the first to N-th row lines, respectively; first to M-th second neuron circuits coupled to the first to M-th column lines, respectively; a plurality of synapses positioned at intersections of the first to N-th row lines and the first to M-th column lines, respectively, each of the plurality of synapses comprising a variable resistance element and a first transistor which are coupled in series, wherein N and M are natural numbers equal to or larger than two; and a t-th gate line to which gates of first transistors coupled to a t-th column line among the first to M-th column lines are coupled, wherein t is a natural number ranging from 1 to M. Using the above configuration, the learning operation and pattern recognition of the neuromorphic device 680 can be improved. As a result, operation characteristic and pattern recognition of the pattern recognition system 600 can be also improved.

The pattern recognition system 600 may further include other components required for performing the functions thereof. For example, the pattern recognition system 600 may further include an input device such as a keyboard or mouse for receiving various parameters or setting conditions required for driving the pattern recognition system 600.

Although various embodiments have been described for illustrative purposes, it will be apparent to those skilled in the art that various changes and modifications may be made without departing from the spirit and scope of the invention as defined in the following claims.

What is claimed is:

1. A neuromorphic device comprising:
first to N-th row lines;
first to M-th column lines;
first to N-th first neuron circuits coupled to the first to N-th row lines, respectively;
first to M-th second neuron circuits coupled to the first to M-th column lines, respectively;
a plurality of synapses positioned at intersections of the first to N-th row lines and the first to M-th column lines, respectively, each of the plurality of synapses comprising a variable resistance element and a first transistor which are coupled in series, wherein N and M are natural numbers equal to or larger than two; and
a t-th gate line to which gates of first transistors coupled to a t-th column line among the first to M-th column lines are coupled, wherein t is a natural number ranging from 1 to M.

2. The neuromorphic device of claim 1, wherein when the t-th column line is a column line having learned specific data, the t-th gate line is driven to turn off the first transistors coupled to the t-th column line during a learning operation of a u-th column line, wherein u is a natural number ranging from 1 to M and is not equal to t.

3. The neuromorphic device of claim 2, wherein during the learning process of the u-th column line, the t-th column line is in a floating state.

4. The neuromorphic device of claim 2, wherein during the learning process of the u-th column line, a u-th gate line is driven to turn on first transistors coupled to the u-th column line.

5. The neuromorphic device of claim 1, wherein the t-th gate line has the same extension direction as the t-th column line.

6. The neuromorphic device of claim 5, further comprising a gate control circuit coupled to the t-th gate line,
wherein a t-th second neuron circuit coupled to the t-th column line and the gate control circuit coupled to the t-th gate line are positioned in opposite sides with respect to the plurality of synapses in the extension direction of the t-th column line.

7. The neuromorphic device of claim 1, wherein the variable resistance element has electrical conductance which gradually changes according to electrical pulses inputted to the first to the N-th row lines, respectively.

8. The neuromorphic device of claim 1, wherein the variable resistance element exhibits an analog behavior according to electrical pulses inputted to the first to N-th row lines, respectively.

9. The neuromorphic device of claim 1, wherein each of the plurality of synapses further comprises a second transistor that is coupled to and disposed between the variable resistance element and the first transistor.

10. The neuromorphic device of claim 9, wherein relative positions of the variable resistance element, the first transistor, and the second transistor are variable.

11. The neuromorphic device of claim 9, further comprising an s-th gate line to which gates of second transistors coupled to an s-th row line among the first to N-th row lines are coupled, wherein s is a natural number ranging from 1 to N.

12. The neuromorphic device of claim 11, wherein the s-th gate line has the same extension direction as the s-th row line.

13. The neuromorphic device of claim 12, further comprising a gate control circuit coupled to the s-th gate line,
wherein an s-th first neuron circuit coupled to the s-th row line and the gate control circuit coupled to the s-th gate line are positioned in opposite sides with respect to the plurality of synapses in the extension direction of the s-th row line.

14. A synapse comprising:
a first transistor; and
a variable resistance element coupled in series to the first transistor,
wherein the first transistor is turned on during a learning operation, and turned off when the learning operation ends.

15. The synapse of claim 14, further comprising:
a second transistor coupled to and disposed between the first transistor and the variable resistance element,
wherein the first transistor is used to control a leakage current on a first set of row and column bases, and the second transistor is used to control a leakage current on a second set of the row and column bases.
